(19) United States
(12) Patent Application Publication
(10) Pub. No.: US 2024/0402678 A1
(43) Pub. Date: Dec. 5, 2024

(54) CONTROL DEVICE AND COMPUTER-READABLE RECORDING MEDIUM STORING PROGRAM

(71) Applicant: Fanuc Corporation, Minamitsuru-gun, Yamanashi (JP)

(72) Inventors: Hiroki Murakami, Minamitsuru-gun, Yamanashi (JP); Hiroyuki Kawamura, Minamitsuru-gun, Yamanashi (JP); Jirou Fujiyama, Minamitsuru-gun, Yamanashi (JP); Naoya Koide, Minamitsuru-gun, Yamanashi (JP)

(73) Assignee: Fanuc Corporation, Minamitsuru-gun, Yamanashi (JP)

(21) Appl. No.: 18/696,754

(22) PCT Filed: Oct. 8, 2021
(86) PCT No.: PCT/JP2021/037434

§ 371 Date: Mar. 28, 2024

(51) Int. Cl. G05B 19/4103

(52) U.S. Cl. CPC G05B 19/4103

(57) ABSTRACT

A control device according to the present disclosure includes a low-pass filter unit that generates a smoothed path by subjecting an indicated path, which is indicated by a control program, to smoothing by a low-pass filter; an inward turning amount calculation unit that calculates an inward turning amount that is the amount of inward turning of the smoothed path generated by the low-pass filter unit relative to the indicated path; and a smoothing processing unit that outputs a path obtained by turning back the smoothed path in a direction opposite to the inward turning direction on the basis of the inward turning amount.

### CROSS REFERENCE TO RELATED APPLICATIONS

This is the U.S. National Phase application of PCT/JP2021/037434, filed Oct. 8, 2021, the disclosure of this application being incorporated herein by reference in its entirety for all purposes.

### FIELD OF THE INVENTION

The present invention relates to a controller and a computer readable storage medium storing a program.

### BACKGROUND OF THE INVENTION

When a control program for machining a smooth free curved surface by using an industrial machine such as a machine tool or an electrical discharge machine is created, a curved line created by computer aided design (CAD) is converted into a sequence of points by computer aided manufacturing (CAM). These points are referred to as instruction points. By being converted into a sequence of instruction points, the curved line is expressed as a plurality of successive micro-line segments.

FIG. 7 is a diagram illustrating a sequence of a plurality of instruction points converted by CAM as an example. In FIG. 7, a plurality of instruction points 422 are illustrated by black circles, and micro-line segments 424 between the instruction points 422 are illustrated by dotted line arrows. As illustrated in FIG. 7, a motion path composed of the micro-line segments 424 has a polyhedral shape. A controller creates a smooth tool path based on a plurality of micro-points or a plurality of micro-line segments instructed by such a control program (for example, Patent Literature 1 and the like). The controller then machines a workpiece while moving a tool relative to the workpiece along the smooth tool path and thereby forms a smooth machined surface.

One of the methods to create a smooth tool path from a plurality of micro-line segments is to perform smoothing using a low-pass filter such as a moving average filter. FIG. 8 illustrates an example of a curved line path created by using a low-pass filter to smooth a polygonal path consisting of a plurality of successive micro-line segments (hereafter, referred to as a smoothing path). FIG. 8 illustrates a smoothing path 426 by a solid line arrow. Smoothing using a low-pass filter has the advantage of reducing the disconnection between adjacent paths.

### PATENT LITERATURE

Patent Literature 1: Japanese Patent Application Laid-Open No. 2000-353006

### SUMMARY OF THE INVENTION

As illustrated in FIG. 8 as an example, the smoothing path 426 resulted from a low-pass filter is a path shifted in a direction of the principal normal vector of a curved line passing through the plurality of instruction points 422 (the inward direction of the curve of the curved line) compared to the original polygonal path. In the present specification, the amount of such a shift is referred to as an inward turning amount. Thus, the smoothing path is smooth but passes through positions shifted from the instruction points 422. That is, machining accuracy (shape accuracy) may be reduced. When performing a smoothing process, it is possible to suppress a reduction in machining accuracy to some degree by setting a tolerance (acceptable error). However, if a stringent tolerance is set to suppress a reduction in machining accuracy, this causes a problem of insufficient smoothness of a path.

Accordingly, a technology to sufficiently smooth a machining path while maintaining machining accuracy is desired.

The controller according to the present disclosure takes an inward turning amount, which is a shift of a path caused when a smoothing process is performed with a low-pass filter, into consideration and performs correction so that a smoothed curved line is closer to a plurality of instruction points. This correction may be performed on a smoothing path after the smoothing process or may be performed on the instruction points to be processed before the smoothing process. The smoothing path or the instruction points are corrected in the opposite direction to the principal normal vector of the curved line passing through the plurality of instruction points (in the outward direction of the curve of the curved line).

To achieve the above, one aspect of the present disclosure is a controller that, based on a control program, controls machining performed by an industrial machine on a workpiece, and the controller includes: a low-pass filter unit that generates a smoothing path by applying smoothing using a low-pass filter to an instruction path instructed by the control program; an inward turning amount calculation unit that calculates an inward turning amount by which the smoothing path obtained by the low-pass filter unit turns to an inward direction relative to the instruction path; and a smoothing processing unit that, based on the inward turning amount, outputs a path pulled back from the smoothing path in an opposite direction to the inward direction in which the smoothing path inwardly turns.

Another aspect of the present disclosure is a computer readable storage medium storing a program that causes a controller to operate, the controller being configured to, based on a control program, control machining performed by an industrial machine on a workpiece, the program causes the controller to operate as: a low-pass filter unit that generates a smoothing path by applying smoothing using a low-pass filter to an instruction path instructed by the control program; an inward turning amount calculation unit that calculates an inward turning amount by which the smoothing path obtained by the low-pass filter unit turns to an inward direction relative to the instruction path; and a smoothing processing unit that, based on the inward turning amount, outputs a path pulled back from the smoothing path in an opposite direction to the inward direction in which the smoothing path inwardly turns.

According to one aspect of the present disclosure, a smooth and accurate path (without any accuracy reduction due to inward turning) is obtained. Thus, a machined workpiece having a smooth machined surface and undeteriorated shape accuracy is obtained.

### BRIEF DESCRIPTION OF DRAWINGS

FIG. 1 is a schematic hardware configuration diagram of a controller according to one embodiment of the present invention.

FIG. 2 is a block diagram illustrating general functions of a controller according to a first embodiment of the present invention.

FIG. 3 is a diagram illustrating an inward turning amount.

FIG. 4 is a block diagram illustrating general functions of a controller according to a second embodiment of the present invention.

FIG. 5 is a block diagram illustrating general functions of a controller according to a third embodiment of the present invention.

FIG. 6 is a block diagram illustrating general functions of a controller according to another embodiment of the present invention.

FIG. 7 is a diagram illustrating a sequence of a plurality of instruction points converted by CAM as an example.

FIG. 8 is a diagram illustrating an example of a smoothing path created by smoothing a polygonal path by using a low-pass filter.

### DETAILED DESCRIPTION OF EMBODIMENTS OF THE INVENTION

Embodiments of the present invention will be described below along with the drawings.

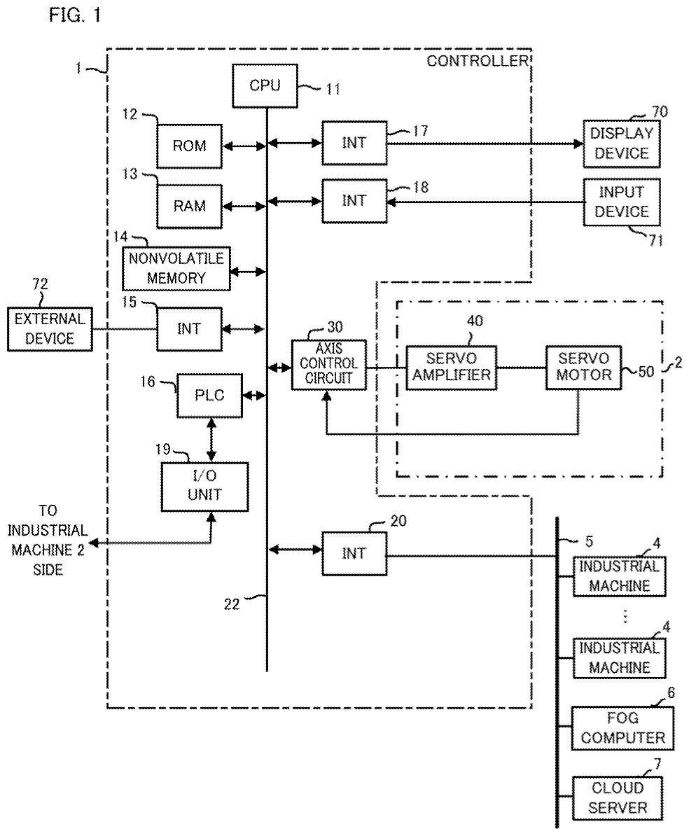

FIG. 1 is a schematic hardware configuration diagram illustrating a main part of a controller according to a first embodiment of the present invention. A controller 1 of the present invention can be installed as a controller that controls an industrial machine such as a machine tool, an electrical discharge machine, a robot, or the like based on a control program, for example. In the following, the controller 1 according to the present embodiment will be described with an example of a controller configured to control a machine tool that moves a tool relative to a workpiece based on the control program to machine the workpiece.

A CPU 11 of the controller 1 according to the present embodiment is a processor that controls the controller 1 as a whole. The CPU 11 reads a system program stored in a ROM 12 via a bus 22 and controls the overall controller 1 in accordance with the system program. A RAM 13 temporarily stores temporal calculation data or display data, externally input various data, and the like.

A nonvolatile memory 14 is formed of a memory, a solid state drive (SSD), or the like backed up by a battery (not illustrated), for example, and the storage state is held even when the controller 1 is powered off. The nonvolatile memory 14 stores data acquired from an industrial machine 2, a control program or data loaded from an external device 72 via an interface 15, a control program or data input via an input device 71, a control program or data acquired from other devices via a network 5, and the like. The control program or data stored in the nonvolatile memory 14 may be loaded into the RAM 13 during execution/during use. Further, various system programs such as a known analysis program are written in the ROM 12 in advance.

The interface 15 is an interface for connecting the CPU 11 of the controller 1 and the external device 72 such as a USB device to each other. For example, a control program, setup data, or the like used for control of the industrial machine 2 are loaded from the external device 72 side. Further, the control program, setup data, or the like edited in the controller 1 can be stored in an external storage device via the external device 72. A programmable logic controller (PLC) 16 executes a ladder program to output signals to and control the industrial machine 2 and peripheral devices of the industrial machine 2 (for example, a tool exchanger, an actuator of a transport robot, a plurality of sensors 3 such as a temperature sensor or a humidity sensor attached to the industrial machine 2) via an I/O unit 19. Further, in response to receiving a signal from various switches of a control panel installed on the main body of the industrial machine 2, peripheral devices, or the like, the PLC 16 performs necessary signal processing thereon and then passes the signal to the CPU 11.

An interface 20 is an interface for connecting the CPU of the controller 1 and the wired or wireless network 5 to each other. To the network 5, other industrial machines 4 such as a machine tool or an electrical discharge machine, a fog computer 6, a cloud server 7, and the like are connected, which transfer data to and from the controller 1.

Each data loaded into the memory, data obtained as a result of execution of a program or the like, or the like are output via the interface 17 and displayed on the display device 70. Further, the input device 71 composed of a keyboard, a pointing device, or the like passes an instruction, data, and the like, which are based on operation by an operator, to the CPU 11 via the interface 18.

An axis control circuit 30 for controlling axes of the industrial machine 2 receives an instruction amount on axis motion from the CPU 11 and outputs the axis instruction to a servo amplifier 40. In response to receiving such an instruction, the servo amplifier 40 drives a servo motor 50 that moves the axis of a machine tool. The servo motor 50 of the axis has a position and speed detector built therein, feeds a position and speed feedback signal from this position and speed detector back to the axis control circuit 30 to perform feedback control on the position and speed. Note that, although only the single axis control circuit 30, the single servo amplifier 40, and the single servo motor 50 are illustrated in the hardware configuration diagram of FIG. 1, these components are prepared for the number of axes of the industrial machine 2 to be controlled in the actual implementation.

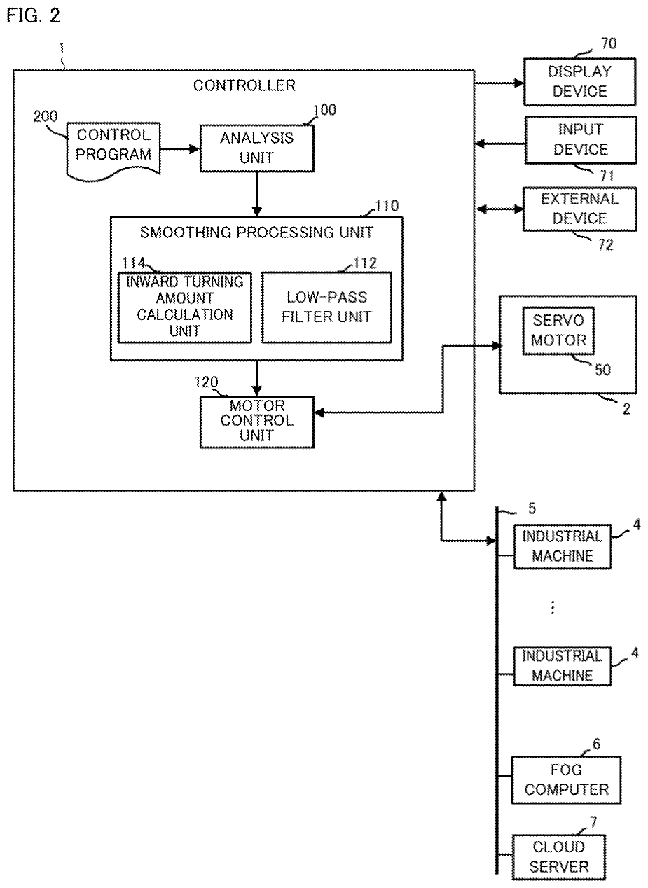

FIG. 2 illustrates functions of the controller 1 according to the first embodiment of the present invention as a schematic block diagram. Each function of the controller 1 according to the present embodiment is implemented when the CPU 11 of the controller 1 illustrated in FIG. 1 executes a system program and controls the operation of each unit of the controller 1.

The controller 1 of the present embodiment includes an analysis unit 100, a smoothing processing unit 110, a low-pass filter unit 112, an inward turning amount calculation unit 114, and a motor control unit 120. Further, the RAM 13 or the nonvolatile memory 14 of the controller 1 stores a control program 200 used for controlling the operation of the industrial machine 2 in advance.

The analysis unit 100 reads and analyzes a block of the control program 200 and generates motion instruction data for the servo motor 50 that drives each unit of the industrial machine 2. Based on a feed instruction instructed by a block of a control program 200, the analysis unit 100 generates data related to a motion instruction to the servo motor 50 that moves a tool of the industrial machine 2 relative to a workpiece. The generated data related to a motion instruction includes at least a sequence of a plurality of instruction points. The analysis unit 100 outputs the generated data related to the motion instruction to the smoothing processing unit 110.

The smoothing processing unit 110 generates, based on data related to a motion instruction input from the analysis unit 100, a smoothing path smoothed from a motion path composed of a sequence of a plurality of instruction points included in the data related to the motion instruction. The smoothing path generated by the smoothing processing unit 110 is generated on consideration of an inward turning amount calculated by the inward turning amount calculation unit 114 and is also based on a curved line path generated by the low-pass filter unit 112.

The low-pass filter unit 112 generates a smoothing path by applying smoothing using a low-pass filter to a path composed of a plurality of micro-line segments obtained by connecting a plurality of instruction points to each other. When applying a low-pass filter to a path composed of a plurality of micro-line segments, the low-pass filter unit 112 defines the path composed of the plurality of micro-line segments as a parametric curve P(t), for example. Herein, P(t) is a vector whose elements are coordinate values on respective axes, and the dimension of the vector matches the number of axes. For example, when the industrial machine 2 moves a tool and a workpiece relative to each other in accordance with an X-axis, a Y-axis, and a Z-axis, P(t) is a three-dimensional vector. The value t is a parameter of a parametric curve. Since the method of using a parametric curve to represent a path instructed by the control program 200 is of a known technique, the description thereof will be omitted. With such definition, if a curved line path resulted from application of a smoothing process to the path P(t) is denoted as Q(t), Q(t) can be calculated by Mathematical equation 1 below. Note that, in Mathematical equation 1, F(l) represents filter operation using a low-lass filter. As the low-pass filter, for example, a known moving average filter, a known Gaussian convolution filter, or the like can be used. In this case, the value l is a parameter representing a filter application range (filter length). The filter length can be calculated based on at least any one of a moving time, a moving distance, and a moving speed of a tool along the instruction path and a time constant defined by the filter. The polygonal path can be sufficiently smoothed when the filter length is set to a degree of the length of a micro-line segment composing a path (to a degree of the time taken to move through a micro-line segment when the parameter t of the parametric curve is a unit of time). When the control program 200 is represented by micro-line segments, the filter length is applied in general with a range longer than the line segment length. This line segment length may be checked in advance before a filter process or may be provided separately.

$$Q ( t ) = F ( l ) \cdot P ( t ) \qquad [ Math . 1 ]$$

As the low-pass filter used in smoothing by the low-pass filter unit 112, other known low-pass filters may be used.

The inward turning amount calculation unit 114 calculates to what degree a smoothing path inwardly turns, namely, the inward turning amount thereof, and herein, the smoothing path is generated by that the low-pass filter unit 112 applies a low-pass filter to a path composed of a plurality of micro-line segments obtained by connecting a plurality of instruction points to each other.

The inward turning amount calculation unit 114 may calculate an inward turning amount by, for example, simply taking a difference between a path composed of a plurality of micro-line sections and a smoothing path. For example, Mathematical equation 2 illustrated below as an example may be used to calculate an inward turning amount at a predetermined parameter cycle. Note that, in Mathematical equation 2, d(t) is an inward turning amount (scalar value) at a position of a predetermined parameter.

$$d ( t ) = \vert Q ( t ) - P ( t ) \vert \qquad [ Math . 2 ]$$

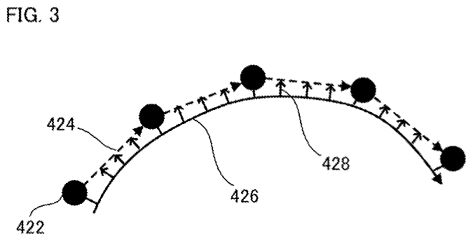

FIG. 3 is a diagram illustrating the inward turning amount of a smoothing path relative to a path composed of a plurality of micro-line segments as an example. In FIG. 3, the instruction points 422 are illustrated by black circles, the micro-line segments 424 are illustrated by dotted line arrows, and the smoothing path 426 is illustrated by a solid line arrow. Note that, for easier understanding of the inward turning amount, FIG. 3 draws the smoothing path so as to more inwardly turn than the actual smoothing path. As illustrated in FIG. 3 as an example, when calculating an inward turning amount by simply taking a difference between a path composed of micro-line segments and a smoothing path, it is possible to calculate the inward turning amount at a position of the instruction point 422 or the inward turning amount at a position for value of a predetermined parameter t between the instruction points 422, for example.

For example, the inward turning amount calculation unit 114 may calculate only the inward turning amount at a position of the instruction point 422 by using Mathematical equation 2 and calculate the inward turning amounts at other positions by on a pro-rata basis or the like. For example, it is assumed that the value of the parameter t at a position of a predetermined instruction point is ts, and the value of the parameter t at a position of the next instruction point is te. In this case, the value “a” illustrated in Mathematical equation 3 below is uniquely defined.

$$t = ( 1 - a ) \times ts + a \times te \qquad [ Math . 3 ]$$

The inward turning amount at a predetermined position between instruction points can be calculated by Mathematical equation 4 below by using the value “a”.

$$d ( t ) = ( 1 - a ) \times \vert Q ( ts ) - P ( ts ) \vert + a \times \vert Q ( te ) - P ( te ) \vert \qquad [ Math . 4 ]$$

The inward turning amount calculation unit 114 can calculate an inward turning amount in an approximation manner based on the curvature of a smoothing curve, for example. A curvature radius R(t) at a predetermined position of the smoothing curve Q(t) can be found by a known analytical method or approximate method from a parametric curve. When the circular arc path with the curvature radius R(t) is denoted as Circle(R), an inward turning amount d(t) satisfies Mathematical equation 5 below. The inward turning amount can be calculated by analytically or approximately solving this Mathematical equation 5 for d(t).

$$d ( t ) = \vert Circle ( R ( t ) ) + d ( t ) ) - F ( l ) \cdot Circle ( R ( t ) + d ( t ) ) \vert \qquad [ Math . 5 ]$$

The smoothing processing unit 110 may generate a smoothing path passing near instruction points by correcting a smoothing path, which has been generated by the low-pass filter unit 112, based on the inward turning amount calculated by the inward turning amount calculation unit 114 in such a way. Another method is to calculate correction points for instruction points moved in advance based on inward turning amounts calculated by the inward turning amount calculation unit 114. Then, the smoothing path passing near instruction points may be generated by using the low-pass filter unit 112 to apply a filter to the corrected motion path composed of a sequence of these plurality of correction points.

The motor control unit 120 controls the servo motor 50 of the industrial machine 2 so that a tool and a workpiece move relative to each other along the smoothing path generated by the smoothing processing unit 110.

In accordance with one aspect of the present disclosure having the configuration described above, a smooth and accurate path (without any accuracy reduction due to inward turning) is obtained. Thus, a machined workpiece having a smooth machined surface and undeteriorated shape accuracy is obtained.

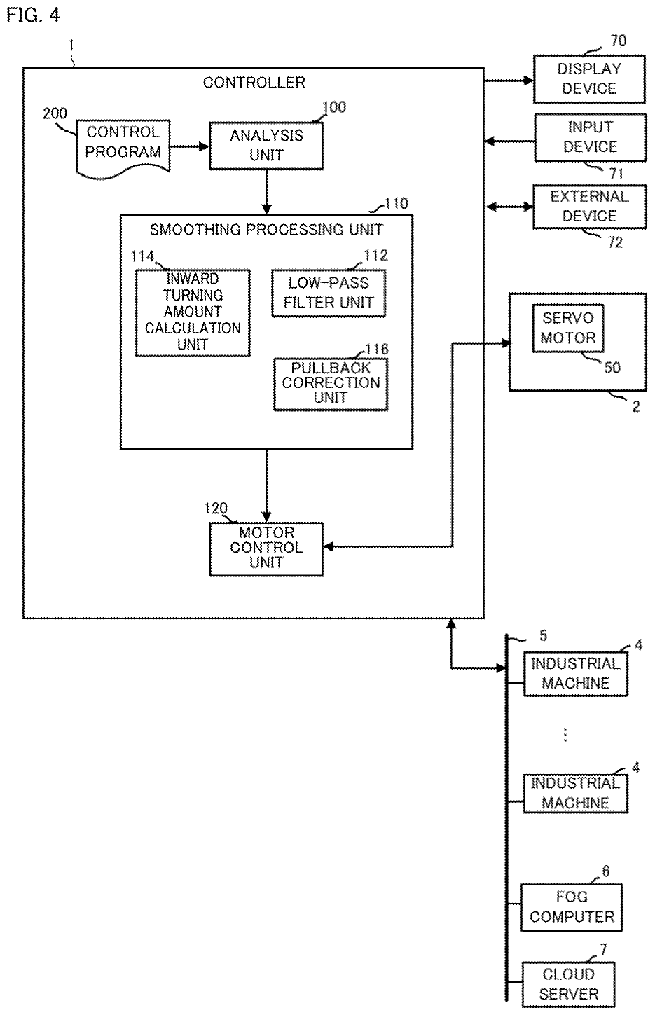

FIG. 4 illustrates functions of the controller 1 according to a second embodiment of the present invention as a schematic block diagram. Each function of the controller 1 according to the present embodiment is implemented when the CPU 11 of the controller 1 illustrated in FIG. 1 executes a system program to control the operation of each unit of the controller 1.

The controller 1 of the present embodiment further includes a pullback correction unit 116 in addition to the analysis unit 100, the smoothing processing unit 110, the low-pass filter unit 112, the inward turning amount calculation unit 114, and the motor control unit 120. Further, the RAM 13 or the nonvolatile memory 14 of the controller 1 stores a control program 200 used for controlling the operation of the industrial machine 2 in advance.

Each function of the analysis unit 100, the low-pass filter unit 112, the inward turning amount calculation unit 114, and the motor control unit 120 is the same as each function of the controller 1 according to the first embodiment.

The smoothing processing unit 110 according to the present embodiment generates a smoothing curve by that, when inward turning occurs on a smoothing path from a plurality of instruction points, the pullback correction unit 116 corrects the smoothing path in the opposite direction to the inwardly turning direction. In other words, correction is made in the opposite direction to the curvature center direction vector (the principal normal vector) of the smoothing path. In the present specification, correction in the opposite direction to the inwardly turning direction is referred to as pullback correction.

The pullback correction unit 116 generates a smoothing curve resulted from pullback correction on the smoothing path generated by the smoothing processing unit 110. For example, the pullback correction unit 116 may perform pullback correction by directly using the inward turning amount calculated by the inward turning amount calculation unit 114. For example, the curvature center at each position of the smoothing curve Q(t) is denoted as QC(t). The curvature unit vector eq(t) in such a case can be expressed by Mathematical equation 6 below.

$$eq ( t ) = \frac{QC ( t ) - Q ( t )}{\vert QC ( t ) - Q ( t ) \vert} \qquad [ Math . 6 ]$$

In such a case, the pullback vector h(t) can be calculated by Mathematical equation 7 below.

$$h ( t ) = d ( t ) \cdot eq ( t ) \qquad [ Math . 7 ]$$

The pullback correction unit 116 can then calculate a smoothing curve S(t) that has been subjected to the pullback correction by using Mathematical equation 8 below.

$$S ( t ) = Q ( t ) - h ( t ) \qquad [ Math . 8 ]$$

The smoothing processing unit 110 outputs a smoothing curve S(t) that has been subjected to pullback correction obtained in such a way to the motor control unit 120 as the final path.

The pullback correction unit 116 may perform a smoothing process as represented by Mathematical equation 9 below when calculating the pullback vector h (t). In Mathematical equation 9, F(l) denotes filter operation by a low-pass filter, the value l denotes a parameter representing a filter application range (filter length). The filter F(l) may be the same as or may be different from the filter used by the low-pass filter unit 112.

$$h ( t ) = F ( l ) \cdot d ( t ) \cdot eq ( t ) \qquad [ Math . 9 ]$$

In accordance with one aspect of the present disclosure having the configuration described above, since an inward turning amount due to a low-pass filter is calculated, and a smoothing curve can be corrected by using the calculated inward turning amount, a smooth and accurate path (without any accuracy reduction due to inward turning) is obtained. Thus, a machined workpiece having a smooth machined surface and undeteriorated shape accuracy is obtained.

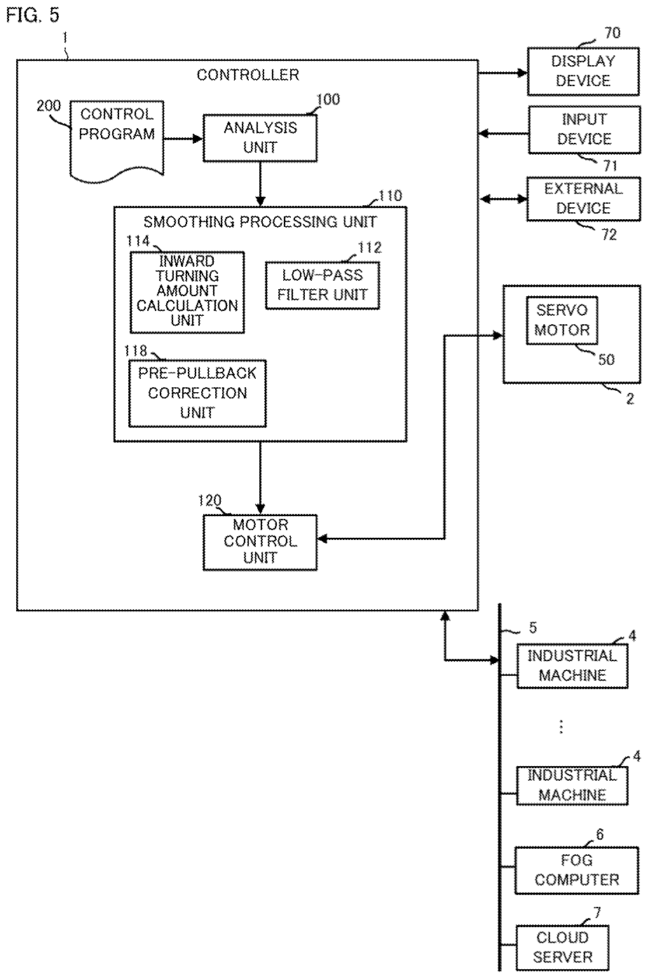

FIG. 5 illustrates functions of the controller 1 according to a third embodiment of the present invention as a schematic block diagram. Each function of the controller 1 according to the present embodiment is implemented when the CPU 11 of the controller 1 illustrated in FIG. 1 executes a system program to control the operation of each unit of the controller 1.

The controller 1 of the present embodiment further includes a pre-pullback correction unit 118 in addition to the analysis unit 100, the smoothing processing unit 110, the low-pass filter unit 112, the inward turning amount calculation unit 114, and the motor control unit 120. Further, the RAM 13 or the nonvolatile memory 14 of the controller 1 stores a control program 200 used for controlling the operation of the industrial machine 2 in advance.

Each function of the analysis unit 100, the low-pass filter unit 112, the inward turning amount calculation unit 114, and the motor control unit 120 is the same as each function of the controller 1 according to the first embodiment.

The smoothing processing unit 110 according to the present embodiment generates correction points corrected in the opposite direction to the inwardly turning direction by using the pre-pullback correction unit 118 for a plurality of instruction points before subjected to the smoothing process. The smoothing processing unit 110 then generates a smoothing curve by using the low-pass filter unit 112 to perform smoothing on the plurality of correction points.

The pre-pullback correction unit 118 performs pre-pullback correction on the plurality of instruction points before subjected to a smoothing process. A method of performing pullback correction in advance will be described below. An instruction path is denoted as a parametric curve P(t) and a curvature radius at each position thereof is denoted as RP(t). When the path is provided as micro-line segments, P(t) becomes polygonal. In such a case, the curvature is found from average shape information in a certain range instead of the curvature being found locally. In general, the curvature at each position can be found by using fitting with a polynomial or the like. For example, a circular arc path with the radius R is denoted as Circle(R). In this case, the inward turning amount can be calculated by Mathematical equation 10 below.

$$d ( t ) = \vert Circle ( RP ( t ) ) - F ( l ) \cdot Circle ( RP ( t ) ) \vert \qquad [ Math . 10 ]$$

Further, the curvature center at each position on P(t) is denoted as PC(t). The curvature unit vector ep(t) in such a case can be expressed by Mathematical equation 11 below.

$$ep ( t ) = \frac{PC ( t ) - P ( t )}{\vert PC ( t ) - P ( t ) \vert} \qquad [ Math . 11 ]$$

By using d(t) and ep(t) found in such a way, a pre-pullback vector hₚᵣₑ(t) can be calculated by Mathematical equation 12 below.

$${h}_{pre} ( t ) = d ( t ) \cdot ep ( t ) \qquad [ Math . 12 ]$$

Then, Mathematical equation 13 is used, and the pre-pullback vector hₚᵣₑ(t) is used to perform pullback correction on P(t) in advance and thereby calculate a corrected instruction path S(t).

$$S ( t ) = P ( t ) - {h}_{pre} ( t ) \qquad [ Math . 13 ]$$

The smoothing processing unit 110 generates a smoothing curve by using the low-pass filter unit 112 to perform smoothing on the corrected instruction path S(t).

In accordance with one aspect of the present disclosure having the configuration described above, inward turning amounts are calculated in advance, and the calculated inward turning amounts are used to perform correction on instruction points. Further, since smoothing is performed on the plurality of corrected instruction points, a smooth and accurate path (without any accuracy reduction due to inward turning) is obtained. A reduction in the computational amount is expected compared to a case where correction is performed after a smoothing curve is calculated.

Although the embodiments of the present invention have been described, the present invention is not limited to only the examples in the embodiments described above and can be implemented in various ways with addition of a suitable change.

For example, in the embodiments described above, the example in which a sequence of a plurality of instruction points is indicated as a path by the control program 200 has been illustrated. Thus, the description has been provided based on the assumption that a micro-line segment is present between instruction points. However, the present invention is applicable not only to a case where the path between instruction points is explicitly specified with a micro-line segment by the control program 200 but also to a case where the path is explicitly specified with a micro-circular arc, a predetermined parametric curve, or the like.

Further, although each value used for calculation of an inward turning amount is calculated from an instruction path or a smoothing path in the embodiments described above, the curvature in each part of the instruction path may be set in an accompanying manner for each block of the control program 200 in advance, for example. The process to add such information can be performed on the CAD/CAM side in advance. With such a configuration, it is possible to reduce the computational load in the controller 1 when performing a smoothing process.

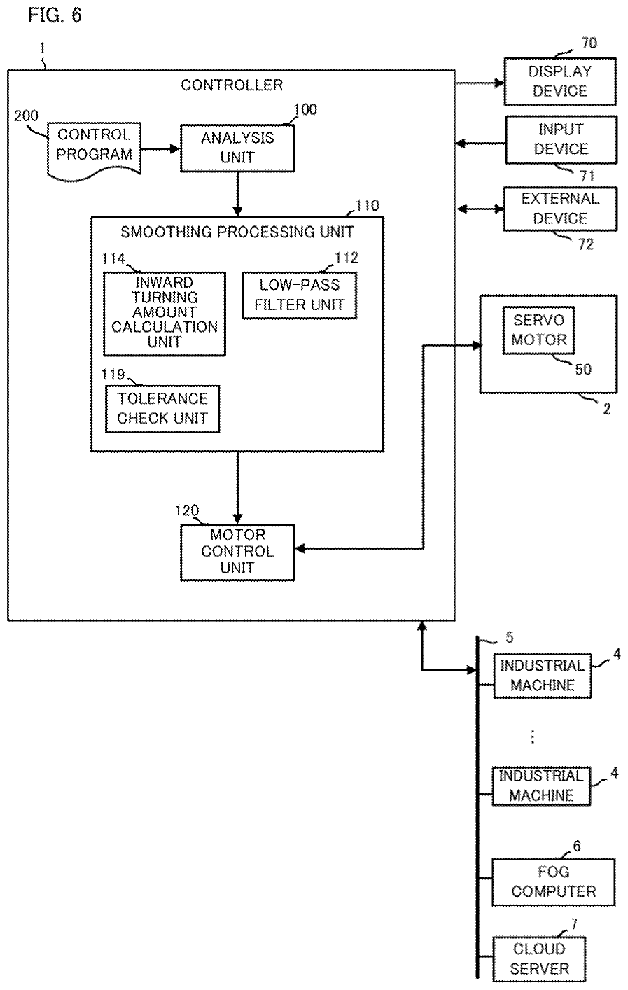

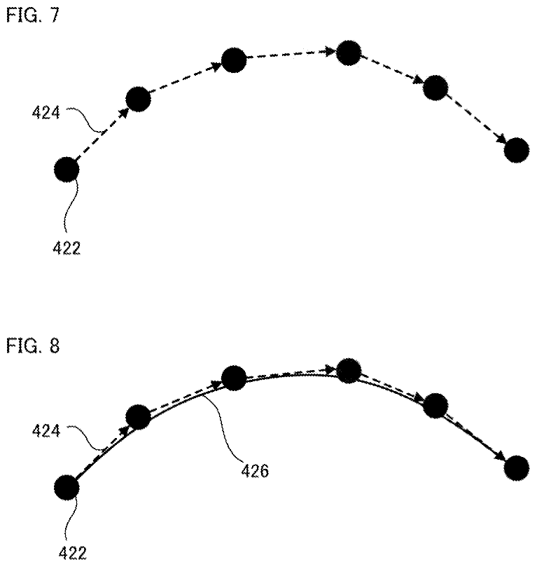

Further, in the embodiments described above, a smoothing path is generated by a single calculation path. However, a smoothing path may be generated by, after generating a smoothing path once, repeating the same process. For example, a smoothing path once created is repeatedly subjected to smoothing by the smoothing processing unit 110. This process is repeated multiple times. It is then possible to increase the accuracy of the pulled-back path by shortening the filter length of the low-pass filter in use to reduce the inward turning amount and the pullback amount as the repetition proceeds. In such a case, for example, as illustrated in FIG. 6 as an example, a tolerance check unit 119 may be provided. A predetermined tolerance (acceptable error) is set in the tolerance check unit 119 in advance. Every time the smoothing process by the smoothing processing unit 110 is performed, the tolerance check unit 119 checks whether or not a change amount (the average change amount or the maximum change amount) of a smoothing path relative to an instruction path is within a tolerance. Then, if the change amount is not within the tolerance, the smoothing process can be repeated. When such a method is used, a path output by the pullback correction unit 116 may be output (second embodiment), or the output of the low-pass filter unit 112 may be output as a final smoothing path (second or third embodiment).

### LIST OF REFERENCE SYMBOLS

1 controller
2, 4 industrial machine
5 network
6 fog computer
7 cloud server
11 CPU
12 ROM
13 RAM
14 nonvolatile memory
15, 17, 18, 20 interface
22 bus
30 axis control circuit
40 servo amplifier
50 servo motor
70 display device
71 input device
72 external device
100 analysis unit
110 smoothing processing unit
112 low-pass filter unit
114 inward turning amount calculation unit
116 pullback correction unit
118 pre-pullback correction unit
119 tolerance check unit
120 motor control unit
200 control program

1. A controller that, based on a control program, controls machining performed by an industrial machine on a workpiece, the controller comprising:
a low-pass filter unit that generates a smoothing path by applying smoothing using a low-pass filter to an instruction path instructed by the control program;
an inward turning amount calculation unit that calculates an inward turning amount by which the smoothing path obtained by the low-pass filter unit turns to an inward direction relative to the instruction path; and
a smoothing processing unit that, based on the inward turning amount, outputs a path pulled back from the smoothing path in an opposite direction to the inward direction in which the smoothing path inwardly turns.

2. The controller according to claim 1,
wherein the smoothing processing unit
comprises a pullback correction unit that performs correction to pull back the smoothing path generated by the low-pass filter unit in the opposite direction to the inwardly turning direction by the inward turning amount calculated by the inward turning amount calculation unit, and
outputs a path corrected by the pullback correction unit.

3. The controller according to claim 1,
wherein the smoothing processing unit
comprises a pre-pullback correction unit that performs correction to pull back the instruction path in advance in the opposite direction to the inwardly turning direction by the inward turning amount calculated by the inward turning amount calculation unit, and
outputs a smoothing path obtained by applying smoothing by using the low-pass filter unit to an instruction path corrected by the pre-pullback correction unit.

4. The controller according to claim 1, wherein the inward turning amount calculation unit defines a difference between the instruction path and the smoothing path as an inward turning amount.

5. The controller according to claim 1, wherein the inward turning amount calculation unit calculates an inward turning amount based on a difference between each of a plurality of instruction points instructed by the control program and the smoothing path.

6. The controller according to claim 1, wherein the inward turning amount calculation unit calculates an inward turning amount based on a curvature of the instruction path and a filter length of the low-pass filter.

7. The controller according to claim 6, wherein a curvature of the instruction path is calculated by using a curvature of the smoothing path.

8. The controller according to claim 6, wherein a curvature of the instruction path is specified as information accompanying the control program.

9. The controller according to claim 6, wherein the filter length is calculated based on at least one of a moving speed along the instruction path and a time constant of the low-pass filter.

10. The controller according to claim 1, wherein the smoothing processing unit repeatedly performs a smoothing process using the inward turning amount calculation unit and the low-pass filter unit on an output path.

11. The controller according to claim 10 further comprising a tolerance check unit that checks whether or not a path change amount is within a specified tolerance,
wherein the smoothing processing unit repeatedly performs a smoothing process until the tolerance check unit determines that the path change amount is within the specified tolerance.

12. A computer readable storage medium storing a program that causes a controller to operate, the controller being configured to, based on a control program, control machining performed by an industrial machine on a workpiece, the program causes the controller to operate as:
a low-pass filter unit that generates a smoothing path by applying smoothing using a low-pass filter to an instruction path instructed by the control program;
an inward turning amount calculation unit that calculates an inward turning amount by which the smoothing path obtained by the low-pass filter unit turns to an inward direction relative to the instruction path; and
a smoothing processing unit that, based on the inward turning amount, outputs a path pulled back from the smoothing path in an opposite direction to the inward direction in which the smoothing path inwardly turns.
